(19) United States
(12) Patent Application Publication
(10) Pub. No.: US 2025/0311750 A1
(43) Pub. Date: Oct. 9, 2025

(54) HIGH-MOISTURE AND PLANT-BASED ALTERNATIVE MEAT WITH NUTRITIONAL BENEFITS AND LONG-TEARING MEAT TEXTURE, ALTERNATIVE MEAT COMPOSITION FOR MANUFACTURING THEREOF, MANUFACUTRING METHOD OF THE SAME ALTERNATIVE MEAT

(71) Applicant: Millennial Flavor Town, Seoul (KR)

(72) Inventor: Bakrin Ahn, Wonju-si (KR)

(73) Assignee: Millennial Flavor Town, Seoul (KR)

(21) Appl. No.: 18/761,153

(22) Filed: Jul. 1, 2024

(30) Foreign Application Priority Data
Apr. 9, 2024 (KR) 10-2024-0047730

(51) Int. Cl. A23J 3/22; A23J 3/16; A23J 3/18; A23J 3/26; A23L 7/10; A23L 31/00

(52) U.S. Cl. CPC A23J 3/227; A23J 3/16; A23J 3/18; A23J 3/26; A23L 7/1975; A23L 31/00

(57) ABSTRACT

The present invention relates to a plant-based high-moisture alternative meat with excellent nutrition and a long tearing meat texture, an alternative meat composition, and a method of producing alternative meat, and specifically to a nutritionally-improved plant-based high-moisture alternative meat that has excellent processability during the extrusion production process and a texture that is torn long like meat, providing a feel and texture similar to animal-based meat, an alternative meat composition for producing the alternative meat and a method of producing the alternative meat.

### CROSS-REFERENCE TO RELATED APPLICATION

This application claims priority to and the benefit of Korean Patent Application No. 10-2024-0047730, filed on Apr. 9, 2024, the disclosure of which is incorporated herein by reference in its entirety.

### BACKGROUND

### 1. Field of the Invention

The present invention relates to a plant-based high-moisture alternative meat with excellent nutrition and a long tearing meat texture, an alternative meat composition, and a method for producing alternative meat, and specifically to a nutritionally-improved plant-based high-moisture alternative meat that has excellent processability during the extrusion production process and a texture that is torn long like meat, providing a feel and texture similar to animal-based meat, an alternative meat composition for producing the alternative meat and a method of producing the alternative meat.

### 2. Discussion of Related Art

Animal-based meat is the main source of protein, providing amino acids in the form of protein to humans. In addition, the fat included in meat also serves as an energy source. However, in modern times, with the development of agricultural and livestock technology and economic prosperity, human consumption of meat has increased significantly, and research has shown that this leads to excessive animal-based fat consumption, which increases blood cholesterol levels and leads to an increase in the number of patients with modern diseases such as obesity and cardiovascular diseases such as high blood pressure or arteriosclerosis.

In addition, in addition to health aspects, environmental pollution problems arising from meat production are also becoming more serious, and in particular, dense livestock breeding facilities used to meet meat consumption in modern livestock farming cause serious air pollution due to carbon dioxide, nitrogen dioxide, methane, and ammonia emitted by livestock, and the excrement produced by these livestock causes soil and groundwater contamination.

Among environmental activists, there is a group that calls for vegetarianism to be encouraged, pointing out the cruelty of the slaughter process to obtain animal-based meat, the impact of livestock farming on the environment, and the negative effects of meat consumption on human health. Some people actually practice vegetarianism themselves. There are many levels of vegetarianism, but the important thing in vegetarianism is not to consume animal-based meat directly.

In order to help people adapt to an unfamiliar diet and supplement insufficient protein in the early stages of becoming a vegetarian, alternative meats such as soybean meat are distributed on the market. However, in reality, this soybean meat cannot taste exactly the same as animal-based meat, and its texture is also not the same, so it does not completely meet consumer demand.

In addition to soybean meat, various types of alternative meat have been introduced to the market, but these alternative meats feel significantly different from existing animal-based meat in terms of sensory quality such as taste and texture, and since the meat-like texture due to the muscle fiber structure of animal-based meat was not imitated at all, its product form was limited to an imitation of pulverized meat, such as a hamburger patty. Accordingly, in order to further improve sensory satisfaction upon consumption, there is a need to develop alternative meat that can provide a texture similar to animal-based meat not only from a nutritional aspect but also from a sensory aspect.

In addition, in the related art, gluten was used in alternative meat to provide a texture similar to animal-based meat, but since the use of gluten has the problem of being difficult to digest and burdensome for people with irritable bowel syndrome, research on methods to reduce the amount of gluten used is needed.

### RELATED ART DOCUMENTS

### Non-Patent Documents

(Non-Patent Document 1) Kaur, Pinderpal, et al. “Rye: A wonder crop with industrially important macromolecules and health benefits.” Food Research International 150 (2021): 110769.
(Non-Patent Document 2) Cervantes-Paz, Braulio, and Elhadi M. Yahia. “Avocado oil: Production and market demand, bioactive components, implications in health, and tendencies and potential uses.” Comprehensive Reviews in Food Science and Food Safety 20.4 (2021): 4120-4158.

### SUMMARY OF THE INVENTION

The present invention is designed to solve the above-described technical problem, and an object of the present invention is to provide a method for producing an alternative meat composition having excellent processability by improving problems such as deterioration or clogging of the discharge port during the process of producing an alternative meat by extrusion molding the alternative meat composition.

In addition, another object of the present invention is to provide an alternative meat which is nutritious, has a fibrous texture similar to animal-based meat, and allows people to perceive a texture and taste similar to animal-based meat, and a composition for producing the alternative meat.

Other objects, specific advantages and novel features of the present invention will become more apparent from the following detailed description and preferred embodiments taken in conjunction with the accompanying drawings.

In order to solve the above-mentioned technical problem, the present invention provides an alternative meat composition including:
50 to 70 parts by weight of a first composition obtained by mixing a mixture of roasted barley, roasted glutinous black rice, and roasted buckwheat, enoki mushrooms and coral mushrooms at a weight ratio of 30 to 60 parts by weight of enoki mushrooms and 30 to 60 parts by weight of coral mushrooms, based on 100 parts by weight of the mixture of the roasted barley, the roasted glutinous black rice, and the roasted buckwheat, adding the resulting mixture to boiling water at a content of 0.3 wt % to 1.5 wt %, and boiling the mixture;
20 to 40 parts by weight of soy protein;
1 to 10 parts by weight of gluten;
5 to 20 parts by weight of rye; and
1 to 7 parts by weight of a vegetable oil.

In a preferred embodiment of the present invention, in the first composition, roasted barley, roasted glutinous black rice, and roasted buckwheat are mixed in a weight ratio of 15 to 35 parts by weight of roasted glutinous black rice and 30 to 45 parts by weight of roasted buckwheat, based on 100 parts by weight of the roasted barley.

In a preferred embodiment of the present invention, the vegetable oil may be one or more selected from avocado oil, sunflower seed oil, soybean oil, olive oil, canola oil, peanut oil, and grapeseed oil. More preferably, the vegetable oil may be avocado oil.

In a preferred embodiment of the present invention, the alternative meat composition may have a sand-like texture by including insoluble particles.

The present invention also provides an alternative meat produced by extruding and cooling the alternative meat composition, and specifically a plant-based high-moisture alternative meat including insoluble fibers that is characterized by being torn long along the grain direction of the fibers when pressure is applied.

In addition, the present invention provides a method of producing an alternative meat, including:
1) roasting a mixture of barley, glutinous black rice, and buckwheat in a weight ratio of 15 to 35 parts by weight of the glutinous black rice and 30 to 45 parts by weight of the buckwheat based on 100 parts by weight of the barley for 3 to 5 minutes;
2) mixing a mixture of the roasted mixture, enoki mushrooms and coral mushrooms at a weight ratio of 30 to 60 parts by weight of enoki mushrooms and 30 to 60 parts by weight of coral mushrooms, based on 100 parts by weight of the roasted mixture, adding the resulting mixture to boiling water at a content of 0.3 wt % to 1.5 wt %, boiling the mixture, and then cooling the same to room temperature to prepare a first composition;
3) mixing 50 to 70 parts by weight of the first composition, 20 to 40 parts by weight of soy protein, 1 to 10 parts by weight of gluten, 5 to 20 parts by weight of rye, and 1 to 7 parts by weight of a vegetable oil, and pulverizing the mixture to prepare a second composition; and
4) discharging the second composition through a twin-screw extruder and cooling the same.

In a preferred embodiment of the present invention, the twin-screw extruder in step 4) may include a heating chamber at 120° C. to 160° C.

The twin-screw extruder in step 4) may include a feeder, and the alternative meat may be produced by extruding the second composition by operating the feeder at a frequency of 10 Hz to 25 Hz and an extrusion screw frequency of 5 Hz to 10 Hz.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a photograph taken to confirm the texture of a composition for producing alternative meat according to one preferred embodiment of the present invention;

FIG. 2 shows a photograph taken to confirm the tearing direction and texture when tearing alternative meat produced according to the related art;

FIG. 3 shows a photograph of a piece of alternative meat produced according to the related art torn using a meat tearing machine;

FIG. 4 shows a photograph taken to confirm the tearing direction and texture when tearing alternative meat according to one preferred embodiment of the present invention;

FIG. 5 shows a photograph of a piece of alternative meat according to one preferred embodiment of the present invention torn using a meat tearing machine;

FIG. 6 shows a graph comparing the hardness of alternative meat according to one preferred embodiment of the present invention with that of animal-based meat;

FIG. 7A shows a photograph of measuring the hardness of beef brisket;

FIG. 7B shows a photograph of measuring the hardness of beef blade meat;

FIG. 7C shows a photograph of measuring the hardness of alternative meat according to one preferred embodiment of the present invention;

FIG. 7D shows a photograph of measuring the hardness of chicken breast; and

FIG. 7E shows a photograph of measuring the hardness of 1++ grade Korean beef tenderloin.

### DETAILED DESCRIPTION OF EXEMPLARY EMBODIMENTS

Hereinafter, each configuration of the present invention will be described in more detail so that those skilled in the art can easily practice it, but this is only one example, and the scope of the present invention is not limited by the following content. The embodiments of the present invention may be modified into various other forms, and the scope of the present invention is not limited to the embodiments described below. In addition, including certain components throughout the specification does not mean excluding other components, unless otherwise stated, but rather means that other components may be further included.

The objectives, specific advantages and novel features of the present invention will become more apparent from the following detailed description and preferred embodiments taken in conjunction with the accompanying drawings. In this specification, when adding reference numbers to components in each drawing, it should be noted that identical components are given the same number as much as possible even when they are shown in different drawings. Hereinafter, in describing the present invention, detailed descriptions of related known technologies that may unnecessarily obscure the subject matter of the present invention will be omitted.

In the case of plant-based alternative meats that were previously developed for vegetarians, although it was possible to achieve a taste similar to animal-based meat by technological advancements, there were limitations in realizing the chewy texture of meat due to the muscle fibers that animal-based meat naturally possesses, and accordingly, as mentioned above, most of the existing alternative meats were limited to realizing the texture of pulverized meat, such as hamburger patties. This was not faithful to its role as an alternative meat in the sense of replacing animal-based meat, and in order to overcome this problem, the present inventors developed a method to produce an alternative meat that gives plant-based alternative meats a texture similar to that of animal-based meat and is also nutritionally superior.

The plant-based high-moisture alternative meat according to the present invention is produced specifically by of 1) preparing an alternative meat composition; and 2) extruding and cooling the alternative meat composition to produce an alternative meat.

Each step is described below.

### 1. Preparation of Alternative Meat Composition

In order to solve the above-mentioned technical problem, the present invention provides an alternative meat composition including 50 to 70 parts by weight of a first composition obtained by mixing a mixture of roasted barley, roasted glutinous black rice, and roasted buckwheat, enoki mushrooms and coral mushrooms at a weight ratio of 30 to 60 parts by weight of enoki mushrooms and 30 to 60 parts by weight of coral mushrooms, based on 100 parts by weight of the mixture of the roasted barley, the roasted glutinous black rice, and the roasted buckwheat, adding the resulting mixture to boiling water at a content of 0.3 wt % to 1.5 wt %, and boiling the mixture,
20 to 40 parts by weight of soy protein,
1 to 10 parts by weight of gluten,
5 to 20 parts by weight of rye, and
1 to 7 parts by weight of a vegetable oil.

Specifically, the first composition may be prepared by i) mixing and roasting barley, glutinous black rice, and buckwheat, and ii) adding a mixture of the roasted barley, roasted glutinous black rice, and roasted buckwheat to boiling water at a content of 0.3 wt % to 1.5 wt %, boiling it, and then cooling it.

Preferably, in step i), barley, glutinous black rice, and buckwheat are mixed in a weight ratio of 15 to 35 parts by weight of glutinous black rice and 30 to 45 parts by weight of buckwheat, based on 100 parts by weight of barley, and roasted over high heat. More preferably, the weight ratio of barley, glutinous black rice, and buckwheat may be 20 to 30 parts by weight of the glutinous black rice and 35 to 40 parts by weight of the buckwheat, based on 100 parts by weight of the barley.

Glutinous black rice is a type of glutinous rice, and when mixed with barley, it can give a certain color to alternative meats and complement the texture of barley, which does not stick together well. These may preferably be roasted over high heat for about 4 to 10 minutes. When roasted for less than 4 minutes, the barley and glutinous black rice may not be sufficiently cooked and may be unsuitable for consumption, and when roasted for more than 10 minutes, they may burn, so it is appropriate to roast them within the above time range.

Alternative meat produced using plant-based ingredients uses plant-based ingredients as the main ingredient and uses the protein included therein to achieve a texture similar to animal-based meat, and the present invention can provide a nutritionally balanced plant-based alternative meat that may be consumed together with carbohydrates and vitamins by adding water mixed with roasted barley and glutinous black rice.

Buckwheat has lower calories than cereals such as barley and rice, making it an alternative meat that is a diet food, and its low gluten content makes it easily digestible for people with irritable bowel syndrome. In addition, because it is difficult to form dough alone due to the low gluten content, the dough needs to be formed by mixing with barley and glutinous black rice.

In step ii), a mixture of roasted barley, glutinous black rice, and buckwheat is added to boiling water, boiled, and then cooled to prepare the first composition.

Preferably, the mixture of the roasted barley, glutinous black rice, and buckwheat can be added to boiling water at a weight ratio of about 0.3 wt % to 1.5 wt %. When the mixture is added at less than 0.3 wt %, the composition for producing alternative meat takes on a shape similar to porridge or soup rather than dough, making it difficult to produce an alternative meat. In addition, when the mixture exceeds 1.5 wt %, the final dough may become too tough and extrusion molding may become difficult, so it is desirable to determine the composition within the above range.

Thereafter, the alternative meat composition according to the present invention is prepared by mixing soy protein, gluten, rye, and a vegetable oil with the first composition obtained by boiling the mixture of roasted barley, glutinous black rice, and buckwheat.

Specifically, an alternative meat composition is prepared by mixing 50 to 70 parts by weight of the first composition, 20 to 40 parts by weight of soy protein, 1 to 10 parts by weight of gluten, 5 to 20 parts by weight of rye, and 1 to 7 parts by weight of vegetable oil.

Gluten is an insoluble protein mixture included in cereals, and is known to form a gluten complex with a three-dimensional network structure when combined with water and hydrated. The gluten complex is formed by forming intra- or intermolecular bonds through various functional groups such as disulfide bonds in plant-based proteins or glutamine amide, which may provide viscoelasticity to the alternative meat composition including soy protein.

Gluten was a material commonly used to impart viscoelasticity not only in the present invention but also in conventional plant-based alternative meats. However, while gluten is useful in various foods, some consumers prefer gluten-free foods, as studies have shown that consuming large amounts of gluten can cause gluten sensitivity or allergies. In the present invention, rye was added to provide a similar texture while lowering the gluten content.

Rye is a type of cereal belonging to the rice family. Rye flour made from ground rye has a lower gluten content than wheat flour made from ground wheat, and includes various nutrients such as dietary fiber fructan and P-glucan, and protein. The present invention has the advantage of producing an alternative meat with rye flour added and providing an alternative meat with higher nutrients compared to the conventional case of using only gluten.

The health benefits of rye include improving bowel function, preventing constipation, delaying gastric emptying by increasing intestinal viscosity, reducing postprandial insulin response rates in diabetic patients, anticancer effects, and reducing cholesterol absorption.

However, rye has a lower gluten content than wheat, so when rye is included excessively, since the plant-based alternative meat composition does not clump together well, it is difficult to mold into meat shape, and when chewed, it has a texture that falls apart in the mouth, so it is necessary to properly combine the content between gluten and rye. When the gluten content is less than 1 part by weight, there may be a crumbling texture and molding difficulties as described above, and when the gluten content exceeds 10 parts by weight, although there is no such problem, it is difficult to provide a highly nutritious plant-based alternative meat according to the present invention, so the purpose of the present invention may not be achieved.

In addition, when the rye content is less than 5 parts by weight, not only can it not achieve the above-mentioned purpose of providing a highly nutritious alternative meat, but it is also impossible to avoid a decrease in texture due to reducing the gluten content to add rye. On the other hand, when the rye content exceeds 20 parts by weight, since the difference in taste and texture compared to general animal-based meat increases, the rye content is preferably adjusted to 20 parts by weight or less when considering consumer preferences.

Soy protein is a high-content protein extracted from soybeans by removing fat and carbohydrates, includes isolated soy protein (ISP), soy protein concentrate (SPC), and textured soy protein (TSP) depending on the production process and protein content, and in the present invention, it is preferable to use soy protein with a high protein content for producing alternative meat with a texture similar to animal-based meat, and preferably isolated soy protein is used.

In one preferred embodiment of the present invention, the vegetable oil may be one or more selected from avocado oil, sunflower seed oil, soybean oil, olive oil, canola oil, peanut oil, and grapeseed oil. More preferably, the vegetable oil may be avocado oil.

Avocado oil includes a large amount of carotenoids, fat-soluble pigments found in large quantities in tomatoes and carrots, its content is significantly higher than that of olive oil, and canola oil, peanut oil, sunflower seed oil, and soybean oil have almost no lipid-soluble bioactive compounds (LSBC) content, so avocado oil is an oil with superior nutrients compared to these oils.

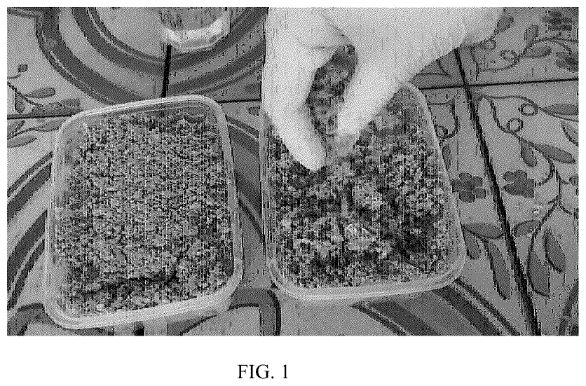

The alternative meat composition mixed in this way may be stirred well into a dough-like form and then pulverized more evenly using a mixer or food processor. A photograph of the pulverized alternative meat composition is shown in FIG. 1. The alternative meat composition according to one preferred embodiment of the present invention may have a sand-like texture rather than a moisture-rich and highly viscous texture such as clay or flour dough.

In this specification, having a sand-like texture means that the material does not form a single lump like a liquid, but that some of the material within the lump is agglomerated to form small particles such as granules.

In the case of the composition having a completely clay or dough-like texture, when feeding the extruder, the feed speed may slow down in the feeder (direct feeder), causing clogging problems. In this case, because the composition cannot be supplied into the extruder at a constant speed, there is a problem that the quality of the final extruded alternative meat deteriorates, the extruder becomes clogged during an extrusion process, and the contents may burn due to the high temperature of the internal heating chamber.

### 2. Extrusion of Alternative Meat Composition and Production of Alternative Meat

The alternative meat composition is produced into a plant-based high-moisture alternative meat according to the present invention through an extrusion molding step of discharging and cooling through a twin-screw extruder.

In one preferred embodiment of the present invention, the twin-screw extruder may include a heating chamber at 120° C. to 160° C. In addition, the number of heating chambers may be 5 or more, and preferably 5 to 9.

When the temperature of the heating chamber is less than 120° C., extrusion may not be performed smoothly due to a decrease in the viscosity of the alternative meat composition, and when it exceeds 160° C., the contents may burn within the extruder and become inedible.

The twin-screw extruder includes a feeder, and the alternative meat may be produced by extruding the alternative meat composition by operating the feeder at a frequency of 10 Hz to 25 Hz and an extrusion screw frequency of 5 Hz to 10 Hz.

Preferably, the alternative meat may be stored in refrigeration and undergo a fermentation process, and the fermentation process may be performed for at least 1 day and within a week. During the fermentation process, the alternative meat composition can have a color similar to animal-based meat.

The present invention also provides an alternative meat produced by extruding and cooling the alternative meat composition, and specifically a plant-based high-moisture alternative meat including insoluble fibers that is characterized by being torn long along the grain direction of the fibers when pressure is applied.

Hereinafter, the effects of the present invention will be described in detail through specific examples and experimental results. The following examples are merely examples to enable a detailed understanding of the embodiments of the present invention, and do not limit the scope of the present invention. A person of ordinary skill in the art who reads this specification will be able to implement the present invention by adding other configurations or deleting or substituting non-essential configurations, except for the essential configurations of the present invention, and this is readily apparent from the description herein, and it should be understood that such embodiments are also within the scope of the present invention.

### EXAMPLE

### Example 1: Production of Alternative Meat Using Rye and Avocado Oil

1) 100 g of barley, 30 g of glutinous black rice, and 40 g of buckwheat were mixed and roasted over high heat for about 4 minutes and 30 seconds while stirring well. About 10 g of the mixture of roasted barley, glutinous black rice, and buckwheat was taken and mixed with 5 g of ground enoki mushrooms and 5 g of ground coral mushrooms, and this mixture was added to 2 L of boiling water, mixed well, and naturally cooled to room temperature to prepare a first composition.

2) About 372 g of the first composition was mixed with about 200 g of soy protein, about 7 g of gluten, 40 g of rye, and about 33 g of avocado oil to obtain a mixture with a total weight of 652 g, which was sufficiently ground in a food processor to prepare an alternative meat composition.

3) The appearance of this alternative meat composition is shown in FIG. 1, and looking at FIG. 1, it can be seen that the alternative meat composition according to Example 1 was a dough with a sand-like texture where particles were visible to the naked eye.

4) The above alternative meat composition was extruded using a twin-screw extruder equipped with five or more heating chambers to produce alternative meat. At this time, the twin-screw extruder used was the ATX-040 model of FESCO PRECISION Co., and extrusion molding was performed while maintaining the temperature of the heating chamber at about 120° C. to 160° C. In addition, extrusion was performed by adjusting the feeder (direct feeder) of the extruder to a frequency of about 10 Hz to 25 Hz and an extruder frequency of about 5 Hz to 10 Hz.

5) The alternative meat composition molded out through the discharge port of the extruder was cooled to room temperature using a cooler of approximately 15° C. to produce alternative meat.

### Comparative Example 1: Production of Alternative Meat Using Gluten

Alternative meat was produced in the same manner as in Example 1, except that 120 g of gluten was added instead of rye to the first composition and mixed to prepare an alternative meat composition, which was extrusion molded to produce alternative meat.

### Experimental Examples

### Experimental Example 1: Texture Evaluation when Meat is Torn by Hand

The alternative meats produced according to Example 1 and Comparative Example 1 were each torn by hand, and the torn shape was compared with the torn shape of general animal-based meat (chicken and lamb).

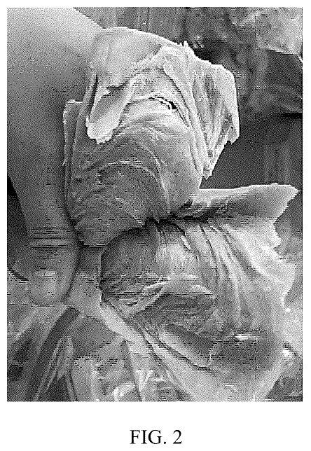

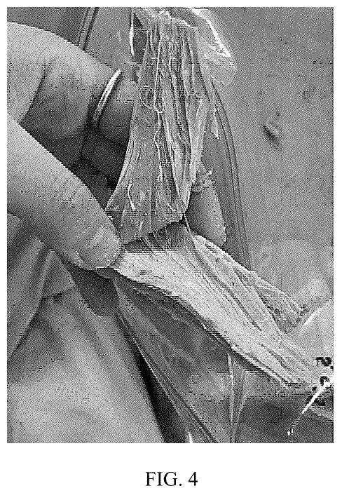

FIG. 4 shows a photograph of the torn shape of the alternative meat according to Example 1, and FIG. 2 shows a photograph of the torn shape of the alternative meat according to Comparative Example 1.

Comparing FIGS. 2 and 4, it was possible to conclude that FIG. 2 shows that even though the meat was torn long along the meat grain, some tearing occurred in the direction perpendicular to the meat grain, and the meat was broken rather than torn long along the meat grain. On the other hand, when looking at FIG. 4, it can be seen that the meat was torn long along the meat grain, almost similar to chicken breast, and tearing in the vertical direction could not be confirmed.

### Experimental Example 2: Evaluation of Tear Shape when Torn Using a Meat Tearing Machine

The alternative meats produced according to Example 1 and Comparative Example 1 were finely torn using a meat tearing machine (product name: Meat shredder SH1) produced by Superior Food Machinery, UK, and then torn shapes were compared.

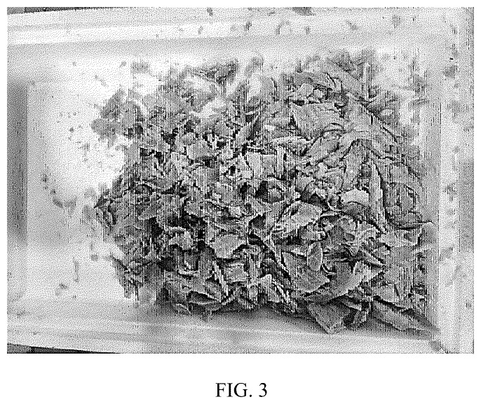

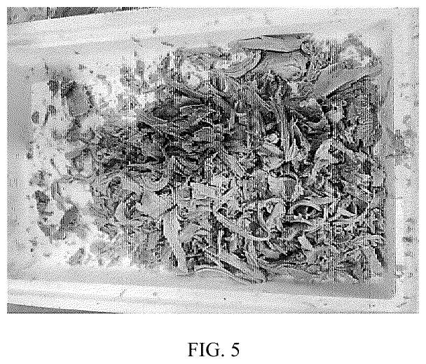

A torn piece of the alternative meat according to Example 1 is shown in FIG. 5, and a torn piece of the alternative meat according to Comparative Example 1 is shown in FIG. 3.

Comparing FIGS. 3 and 5, it can be seen that the alternative meat of Comparative Example 1 in FIG. 3 has a sawdust-like appearance as no particular direction is visible in the finely torn pieces, whereas the alternative meat of Example 1 in FIG. 5 shows that most of the pieces are torn with a long shape along the meat grain, so it has the same meat quality as actual animal-based meat.

In particular, referring to FIG. 5, it can be seen that the torn shape of the alternative meat according to Example 1 is almost similar to chicken breast, which is actual animal-based meat. Therefore, it was found that the alternative meat according to Example 1 had a texture similar to chicken breast.

### Experimental Example 3: Measurement of Hardness and Elasticity

To measure the meat texture of the alternative meat according to Example 1, hardness and elasticity (springiness) were each measured. Measurements were made by analyzing the force applied by poking the test piece of meat or alternative meat with a hardness measuring probe. The hardness and elasticity of the alternative meat produced according to Example 1 were compared with 1++ grade Korean beef tenderloin, chicken breast, blade meat, and brisket, and the experiment was performed using samples cut into the same steak shape. The results are shown in Table 1 below, and in the case of hardness, each sample was measured twice, and all results are listed.

TABLE 1

| | Hardness (N) | Elasticity (N) |
|---|---|---|
| Example 1 | 0.989/0.889 | 0.80 |
| 1++ Korean beef tenderloin | 1.52/1.34 | 0.67 |
| Chicken breast | 1.66/1.09 | 0.70 |
| Blade meat | 3.39/2.92 | 0.67 |
| Brisket | 4.92/4.16 | 0.66 |

As can be seen in Table 1 above, the alternative meat produced according to Example 1 has a hardness significantly lower than that of blade meat and brisket and even lower than that of 1++ grade Korean beef tenderloin, and has a similar texture. In addition, there was no significant difference in elasticity compared to the 1++ grade Korean beef tenderloin, showing that it can provide a texture similar to high-grade beef.

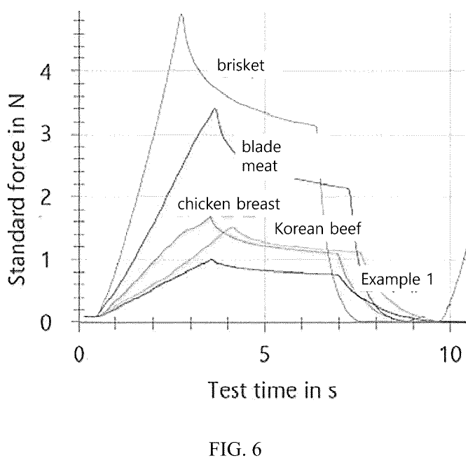

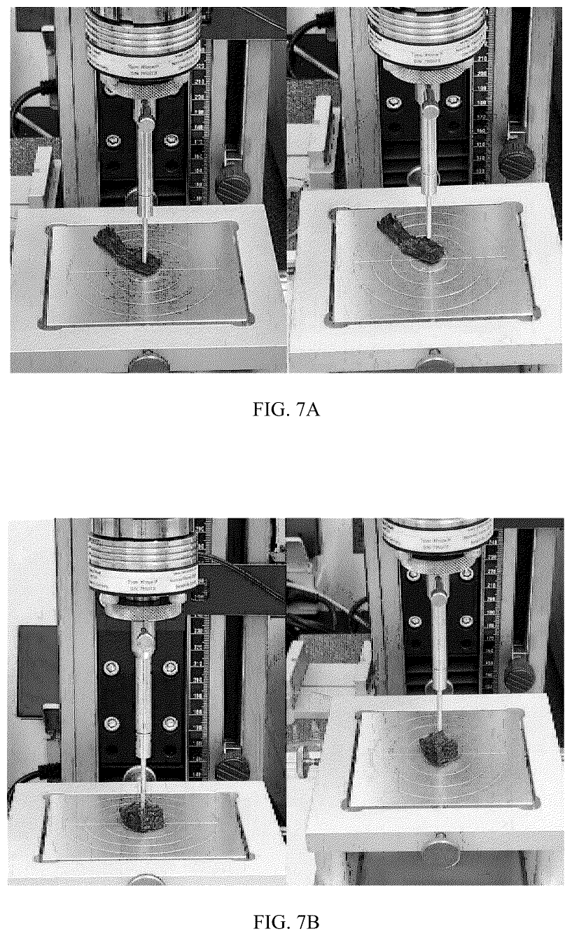

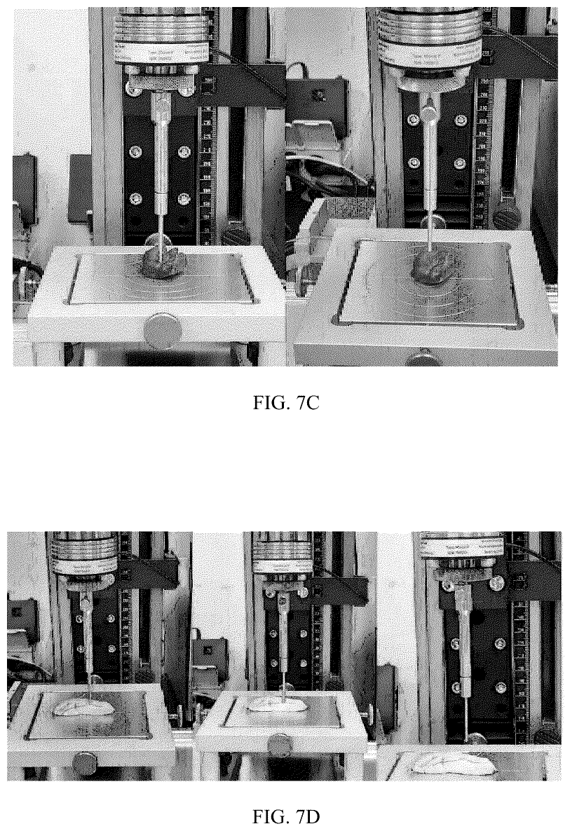

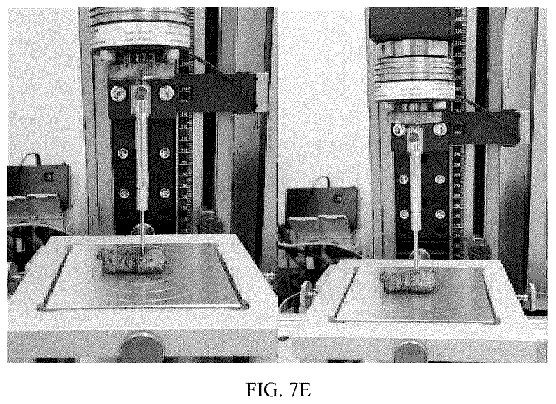

FIG. 6 shows the force measured over time by pressing and releasing the animal-based meat shown in Table 1 and the alternative meat of Example 1 twice using a hardness meter, and the values shown in Table 1 refer to the Y-axis values of the two peaks.

Referring to FIG. 6, the pattern in the graph is divided into group A with peaks of 2 N or less, group B with peaks from 2 N to 5 N, and group C with peaks of 5 N or more, and group A includes 1++ Korean beef, chicken breast, blade meat, and the alternative meat of Example 1, and group C includes brisket.

In the graph of FIG. 6, hardness is a measure of the force applied at the point when the probe begins to compress the meat, and appears in the order of brisket, blade meat, chicken breast, Korean beef, and the alternative meat of Example 1. It can be seen that the hardness measurement value of the alternative meat of Example 1, compared to that of animal-based meat such as brisket, blade meat, chicken breast, and 1++ Korean beef tenderloin, shows a similar pattern in the graph shape. This means that when consuming the alternative meat according to Example 1, the texture received by the eater during the chewing action is very similar to animal-based meat.

In particular, it can be seen that the shape of the measurement graph according to Example 1 shows a significant difference in the hardness value of the meat compared to the measurement results of parts with a relatively tough texture such as brisket and blade meat among animal meats, and shows the most similar hardness value to 1++ grade Korean beef tenderloin. From this, it can be expected that the alternative meat according to Example 1 of the present invention will be able to provide a soft texture like 1++ grade Korean beef tenderloin compared to tough parts such as beef brisket or blade meat among actual animal-based meats.

Elasticity is a measure of the force applied to the probe as each sample compressively deformed by the probe returns to its original state by gradually removing the force applied to the probe, and the strength was shown in the following order: chicken breast, the alternative meat of Example 1, 1++ Korean beef tenderloin, blade meat, and brisket.

Cohesiveness can also be seen from the data obtained from the graph above, and refers to the property of each sample to be present in a form that maintains its original strength, and was shown in the following order: chicken breast, the alternative meat of Example 1, brisket, and blade meat. From this, viscosity (gumminess) could be confirmed, which is the product of cohesion and hardness and a property that indicates the degree to which a semi-solid substance can be swallowed, and the values appeared in the order of brisket, chicken breast, blade meat, and the alternative meat of Example 1. In addition, chewiness can be interpreted as the property of the degree to which a solid sample can be swallowed, and is expressed as the product of viscosity and elasticity. This appeared in the order of chicken breast, brisket, blade meat, and the alternative meat of Example 1.

All of the above samples were meat (including alternative meats), and Example 1 was judged to have a higher protein content than other animal-based meats, and each sample was judged to have physical properties measured according to the protein content.

### Advantageous Effects

The alternative meat composition according to the present invention has the advantage of excellent processability by improving problems such as deterioration or clogging of the discharge port during the process of producing an alternative meat by extrusion molding.

In addition, when the alternative meat composition is produced into alternative meat by the method of producing alternative meat according to the present invention, the alternative meat is nutritious and has a fibrous texture similar to animal-based meat, allowing people who consume it to feel a texture and taste similar to animal-based meat.

What is claimed is:

1. An alternative meat composition comprising:
50 to 70 parts by weight of a first composition obtained by mixing a mixture of roasted barley, roasted glutinous black rice, and roasted buckwheat, enoki mushrooms and coral mushrooms at a weight ratio of 30 to 60 parts by weight of enoki mushrooms and 30 to 60 parts by weight of coral mushrooms, based on 100 parts by weight of the mixture of the roasted barley, the roasted glutinous black rice, and the roasted buckwheat, adding the resulting mixture to boiling water at a content of 0.3 wt % to 1.5 wt %, and boiling the mixture;
20 to 40 parts by weight of soy protein;
1 to 10 parts by weight of gluten;
5 to 20 parts by weight of rye; and
1 to 7 parts by weight of a vegetable oil.

2. The alternative meat composition of claim 1, wherein in the first composition, roasted barley, roasted glutinous black rice, and roasted buckwheat are mixed in a weight ratio of 15 to 35 parts by weight of roasted glutinous black rice and 30 to 45 parts by weight of roasted buckwheat, based on 100 parts by weight of the roasted barley.

3. The alternative meat composition of claim 1, wherein the vegetable oil is one or more selected from avocado oil, sunflower seed oil, soybean oil, olive oil, canola oil, peanut oil, and grapeseed oil.

4. The alternative meat composition of claim 1, wherein the vegetable oil is avocado oil.

5. The alternative meat composition of claim 1, wherein the alternative meat composition has a sand-like texture by including insoluble particles.

6. An alternative meat produced by extruding and cooling the alternative meat composition according to claim 1, wherein the alternative meat is a plant-based high-moisture alternative meat including insoluble fibers that are torn long along the grain direction of the fibers when pressure is applied.

7. A method of producing an alternative meat, comprising:
1) roasting a mixture of barley, glutinous black rice, and buckwheat in a weight ratio of 15 to 35 parts by weight of the glutinous black rice and 30 to 45 parts by weight of the buckwheat based on 100 parts by weight of the barley for 3 to 5 minutes;
2) mixing a mixture of the roasted mixture, enoki mushrooms and coral mushrooms at a weight ratio of 30 to 60 parts by weight of enoki mushrooms and 30 to 60 parts by weight of coral mushrooms, based on 100 parts by weight of the roasted mixture, adding the resulting mixture to boiling water at a content of 0.3 wt % to 1.5 wt %, boiling the mixture, and then cooling the same to room temperature to prepare a first composition;
3) mixing 50 to 70 parts by weight of the first composition, 20 to 40 parts by weight of soy protein, 1 to 10 parts by weight of gluten, 5 to 20 parts by weight of rye, and 1 to 7 parts by weight of a vegetable oil, and pulverizing the mixture to prepare a second composition; and
4) discharging the second composition through a twin-screw extruder and cooling the same.

8. The method of claim 7, wherein the twin-screw extruder in step 4) includes a heating chamber at 120° C. to 160° C.

9. The method of claim 7, wherein the twin-screw extruder in step 4) includes a feeder, and the feeder operates at a frequency of 10 Hz to 25 Hz and an extrusion screw frequency of 5 Hz to 10 Hz to extrude the second composition.
